(19) United States
(12) Patent Application Publication
(10) Pub. No.: US 2017/0068532 A1
(43) Pub. Date: Mar. 9, 2017

(54) MANAGEMENT APPARATUS, MANAGEMENT METHOD, AND COMPUTER-READABLE RECORDING MEDIUM

(71) Applicant: FUJITSU LIMITED, Kawasaki-shi (JP)

(72) Inventor: Takashi KOBAYASHI, Chiba (JP)

(73) Assignee: FUJITSU LIMITED, Kawasaki-shi, (JP)

(21) Appl. No.: 15/229,580

(22) Filed: Aug. 5, 2016

(30) Foreign Application Priority Data
Sep. 9, 2015 (JP) 2015-177990

(51) Int. Cl. G06F 9/445; H04L 29/08; G06F 9/44

(52) U.S. Cl. CPC G06F 8/65; G06F 8/71; H04L 67/34

(57) ABSTRACT

A management apparatus that manages data centers specifies a version of software to be used by a user. The management apparatus determines whether or not the software of the version specified is held in a first data center to be used by the user. The management apparatus instructs the first data center to download the software of the version from a second data center that holds the software of the version when the software of the version is not held in the first data center.

### CROSS-REFERENCE TO RELATED APPLICATION

This application is based upon and claims the benefit of priority of the prior Japanese Patent Application No. 2015-177990, filed on Sep. 9, 2015, the entire contents of which are incorporated herein by reference.

### FIELD

The embodiments discussed herein are related to a management apparatus, a management method, and a computer- readable recording medium.

### BACKGROUND

In recent years, outsourcing services, which provide services by using a plurality of data centers without being limited to regions or countries, become widespread with the popularization of virtual machines or the like. For example, the outsourcing services homogeneously provide service management, operation, service platforms, facilities, and networks under a unified concept and standardized service management without being subject to geographical and physical restrictions.

A control center that manages the data centers is provided for such outsourcing services. For example, because software products that are used by a customer may be executed in different data centers so as to make management in each of the data centers cumbersome and complicated, the control center collectively manages information on software products that are executed in the data centers.

Patent document 1: Japanese Laid-open Patent Publication No. 2013-117889

Patent document 2: Japanese Laid-open Patent Publication No. 2011-002932

However, the aforementioned conventional technology has a problem in that a processing load of the control center increases because the control center installs software products in the data centers and updates the installed software products in the form of download, for example. As a result, the download of the software products may be delayed to load to an adverse impact on the services in some cases.

### SUMMARY

According to an aspect of the embodiment, a management apparatus that manages data centers includes a memory; and a processor that is connected to the memory, wherein the processor executes a process. The process includes specifying a version of software to be used by a user; determining whether or not the software of the version specified at the specifying is held in a first data center to be used by the user, and instructing the first data center to download the software of the version from a second data center that holds the software of the version when the software of the version is not held in the first the data center.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating an overall configuration example of a system according to a first embodiment;

FIG. 2 is a functional block diagram illustrating a functional configuration of a management server according to the first embodiment;

FIG. 3 is a diagram illustrating an example of information that is stored in a customer information database;

FIG. 4 is a diagram illustrating an example of information that is stored in a center information database;

FIG. 5 is a diagram illustrating an example of information that is stored in a center load database;

FIG. 6 is a flowchart illustrating the flow of processing when a contract is made with a customer;

FIG. 7 is a flowchart illustrating the flow of processing when the contract is changed;

FIG. 8 is a diagram illustrating a specific example of a download source;

FIG. 9 is a diagram illustrating an overall configuration example of a system according to a second embodiment;

FIG. 10 is a flowchart illustrating the flow of processing when a patch is applied; and

FIG. 11 is a diagram illustrating a hardware configuration example.

### DESCRIPTION OF EMBODIMENTS

Preferred embodiments will be explained with reference to accompanying drawings. In addition, the disclosed technology is not limited to the embodiments described below.

### First Embodiment

Overall Configuration

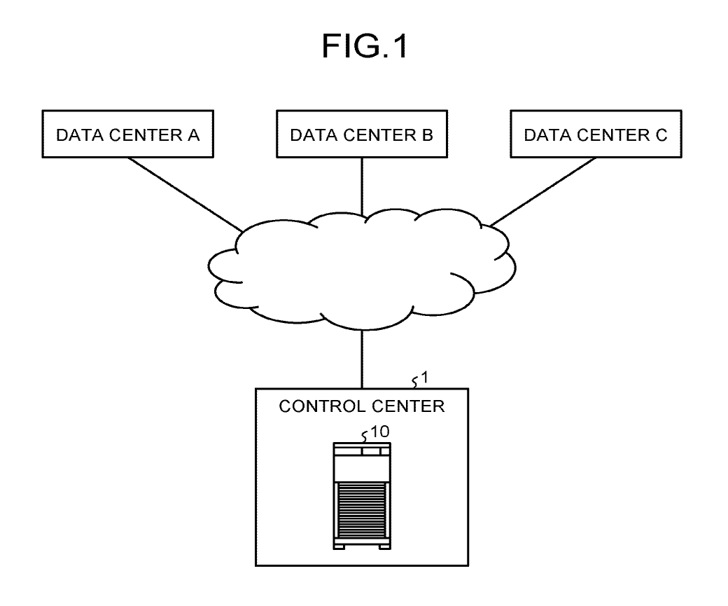

FIG. 1 is a diagram illustrating an overall configuration example of a system according to the first embodiment. As illustrated in FIG. 1, the system includes a control center 1, a data center A, a data center B, and a data center C.

Each of the data centers (hereinafter, may be referred to as “DC”) is provided with physical servers. Each of the data centers provides various functions of servers such as Web servers, database servers (DB servers), and application servers to provide an operational system by using physical servers or virtual machines. The control center 1 is provided with a management server 10, and is a data center that manages information on each of the data centers and information on customers who use the data centers.

For example, a customer K can use any of the data centers if the customer makes a system use contract with a providing company that provides the system illustrated in FIG. 1. In addition, the customer K can change the contract during the use of the system to change the data center and the server in use.

When the customer uses the system in this way, the management server 10 of the control center 1 specifies a version of software to be used by the user. The management server 10 determines whether or not the software of the specified version is saved in a first data center to be used by the user. The management server 10 instructs the first data center to download the software of the version from a second data center that holds the software of the version when it is determined that the software of the version is not saved in the first data center.

For example, when a version/level (hereinafter, may be referred to as “V/L”) of software to be used by the user does not operate in a target DC to be used by the user, the management server 10 makes the target DC download the V/L from another DC. As a result, the load of the control center 1 caused by downloads can be reduced.

Functional Configuration

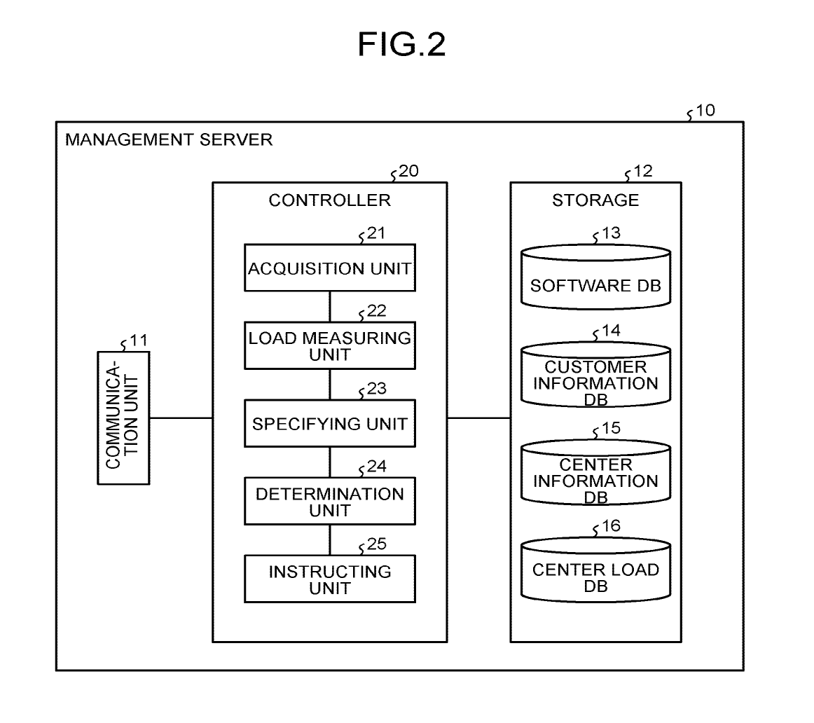

Next, a functional configuration of the management server 10 will be explained. FIG. 2 is a functional block diagram illustrating a functional configuration of the management server 10 according to the first embodiment. As illustrated in FIG. 2, the management server 10 includes a communication unit 11, a storage 12, and a controller 20.

The communication unit 11 is a communication interface that controls communication with other devices in a wired or wireless way. For example, the communication unit 11 receives a load situation or the like from each of the data centers and sends various instructions to each of the data centers.

The storage 12 is a database that stores programs and data that are executed by the controller 20, and is a hard disk drive or a memory, for example. The storage 12 stores a software database 13, a customer information database 14, a center information database 15, and a center load database 16.

The software database 13 is a database that stores software downloaded by the management server 10 from a provider or the like of the software. Specifically, the software database 13 stores software programs corresponding to versions and levels.

The customer information database 14 is a database that stores information on customers who use the system. Specifically, the customer information database 14 stores information on the data centers and software that are used by the customers. The stored information is updated at any time by a change or the like in the contract details of the customers.

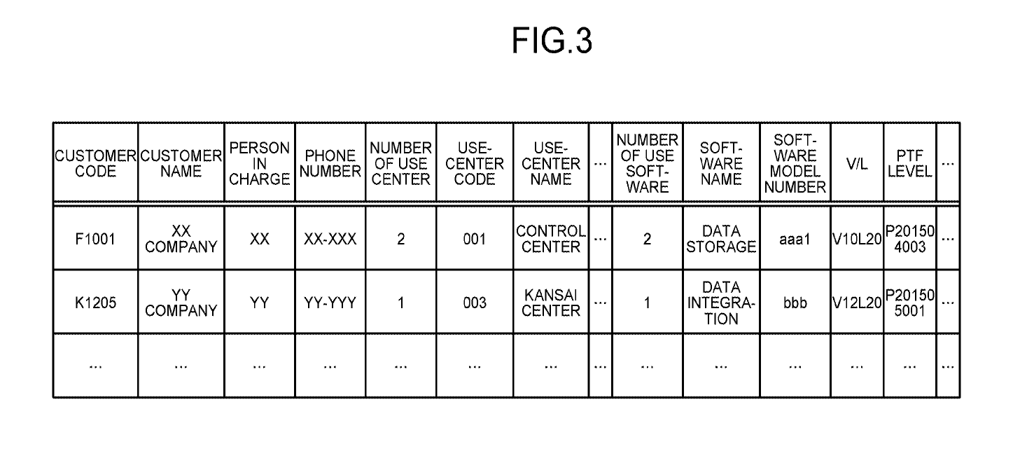

FIG. 3 is a diagram illustrating an example of information that is stored in the customer information database 14. As illustrated in FIG. 3, the customer information database 14 stores “customer code, customer name, person in charge, phone number, number of use centers, use-center code, use-center name, . . . , number of use softwares, software name, software model number, V/L, and PTF (Program Temporary Fix) level”. “Use-center code and use-center name” are set for the number of data centers to be used. “Software name, software model number, V/L, and PTF level” are set for the number of software products to be used.

The stored “customer code” is an identifier that identifies a customer, “customer name” is a customer's appellation such as a company name, “person in charge” is a name of a person in charge of the customer, and “phone number” is a phone number of the person in charge. “Number of use centers” is the number of data centers to be used by the customer, “use-center code” is an identifier assigned to DC to be used by the customer, and “use-center name” is an appellation of the DC to be used by the customer. “Number of use softwares” is the number of software products to be used by the customer, “software name” is an appellation of the software to be used by the customer, “software model number” is a model number of the software, “V/L” is the version and level of the software, and “PTF level” is a level of Program Temporary Fix and is information on a version or the like of a program that modifies software.

In the example of FIG. 3, the customer code “F1001” is assigned to “XX company”, the person in charge of this customer is “XX”, and “'XX-XXX” is registered as the phone number. This customer is using “2” data centers, and the first of the two DCs is the “control center” whose use-center code is “001”. The explanation of the second DC will be omitted for convenience of explanation. Moreover, this customer is using “2” software products. With respect to the first of the two software products, the software name is “data storage”, the model number is “aaa1”, the V/L is “V10L20”, and the PTF level is “P201504003”. The explanation of the second software will be omitted for convenience of explanation.

The center information database 15 is a database that stores information on data centers. Specifically, the center information database 15 stores information on what kind of software is executed in each of the data centers.

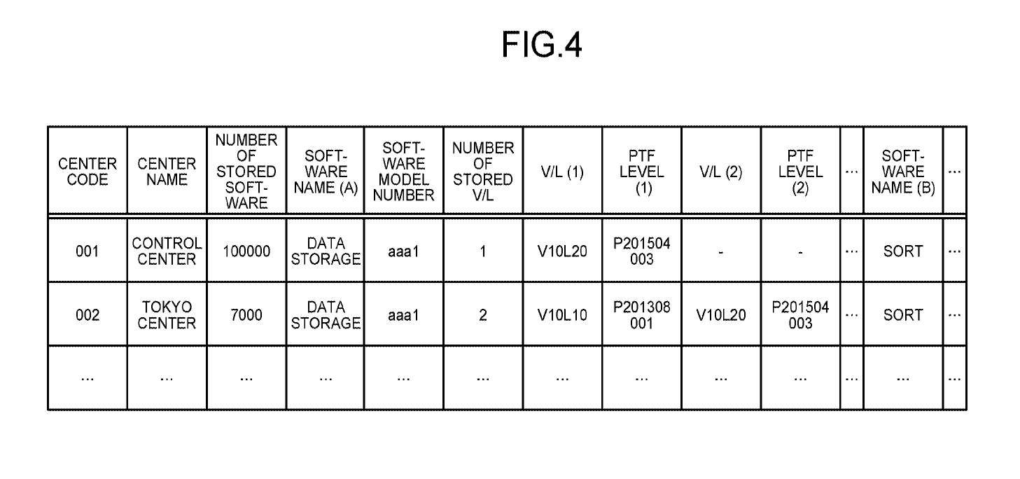

FIG. 4 is a diagram illustrating an example of information that is stored in the center information database 15. As illustrated in FIG. 4, the center information database 15 stores “center code, center name, number of stored softwares, software name (A), software model number, number of stored V/L, V/L (1), PTF level (1), V/L (2), PTF level (2), etc.” The “V/L and PTF level” are set for the number of versions/levels saved in the data centers.

The stored “center code” is an identifier that is assigned to the DC, “center name” is an appellation of the DC, and “number of stored softwares” is the number of software products saved in the DC. “Software name (A)” is an appellation of the first software to be stored, “software model number” is a model number of the software name (A), “V/L (1)” is the version and level of the software name (A), and “PTF level (1)” is PTF level of the software name (A). “V/L (2)” is the version and level of the software name (A), and “PTF level (2)” is PTF level of the software name (A).

In FIG. 4, an example is illustrated in which “100000” software products are saved in the “control center” whose center code is “001”. The software name “data storage” whose model number is “aaa1”, V/L is “V10L20”, and PTF level is “P201504003” is saved in the “control center”. In the “Tokyo center” whose center code is “002”, two version/levels are stored with respect to the software name “data storage”.

The center load database 16 is a database that stores load information of the centers. Specifically, the center load database 16 stores load information on a communication situation between each of the centers including the control center 1 and other centers.

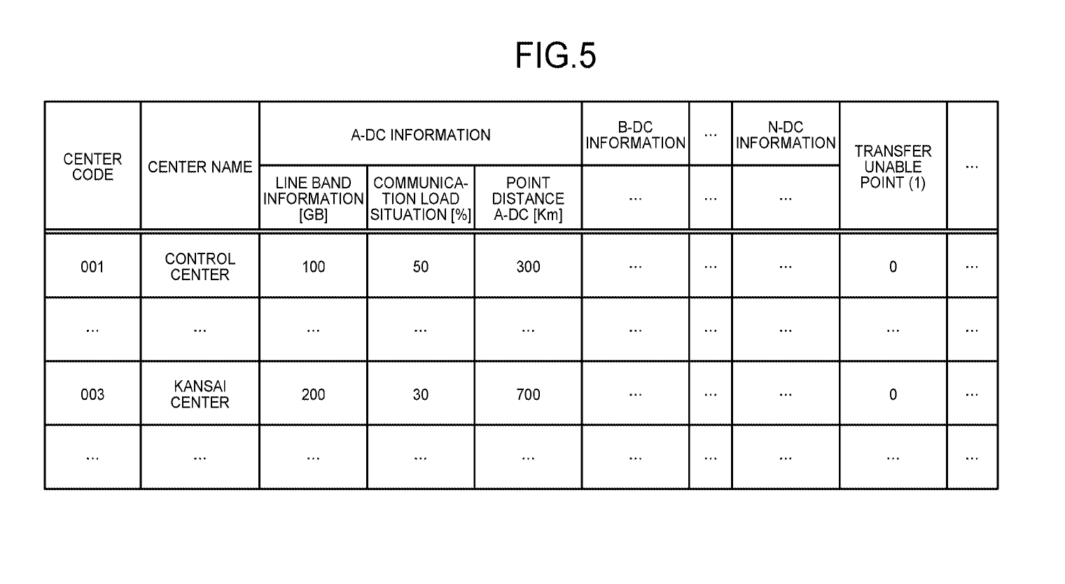

FIG. 5 is a diagram illustrating an example of information that is stored in the center load database 16. As illustrated in FIG. 5, the center load database 16 stores “center code, center name, A-DC information (information on data center A), B-DC information, . . . , N-DC information, transfer-unable point (1), etc.” The center load database 16 stores load information and the transfer-unable points of each of the data centers.

The stored “center code” is an identifier assigned to the DC and “center name” is an appellation of the DC. “A-DC information” is information that indicates a communication load between a data center set to the center name and the data center A. “Line band information (GB)” of “A-DC information” is a line band between the data center set to the center name and the data center A. “Communication load situation (%)” is a communication load between the data center set to the center name and the data center A. “Point distance: A-DC (Km)” is a geographical distance between the data center set to the center name and the data center A. “Transfer-unable point” is DC that is excluded from data transfer destinations of the data center set to the center name.

An example illustrated in FIG. 5 indicates that a distance between “control center” and “data center A” is 300 Km, these centers are connected to each other via a “100 GB” line, and the present communication load is “50%”. It also indicates that no data centers are excluded from the data transfer destinations of the “control center”.

The controller 20 is a processing unit, such as a processor, which totally manages the management server 10. The controller 20 includes an acquisition unit 21, a load measuring unit 22, a specifying unit 23, a determination unit 24, and an instructing unit 25. The acquisition unit 21, the load measuring unit 22, the specifying unit 23, the determination unit 24, and the instructing unit 25 are an example of electronic circuitry included in a processor or an example of processes executed by the processor.

The acquisition unit 21 is a processing unit that acquires software, patches, or the like. Specifically, the acquisition unit 21 acquires software programs, updated programs, patches, or the like from a software provider, and updates the software database 13. The acquisition unit 21 updates information corresponding to the control center 1 that is stored in the center information database 15 in accordance with information on the acquired software. Moreover, at timing at which software is updated or when there is not software to be used by the customer after a contract is made at the desire of the customer, the acquisition unit 21 acquires the updated software program or the desired software from the provider.

The load measuring unit 22 is a processing unit that measures load situations of each of the data centers. Specifically, the load measuring unit 22 measures a load situation of each of the data centers periodically or at timing instructed by an administrator or the like and updates the center information database 15 in accordance with the measured load situation. The load measuring unit 22 can also measure the load situations of each of the data centers in various known methods and can also acquire information measured by each of the data centers.

For example, the load measuring unit 22 measures a communication load of a line between the control center 1 and the data center A, and stores the communication load in the center information database 15. The load measuring unit 22 acquires from the data center A load information on a line between the data center A and the data center B, and stores the acquired information in the center information database 15. The line band information and the point distance that are stored in the center information database 15 are statically set at the time of the contract. However, they are appropriately updated when the contract information is changed.

The specifying unit 23 is a processing unit that specifies the version of software that is used by the customer. Specifically, the specifying unit 23 specifies software to be used by the customer and the V/L of the software with reference to the customer information database 14 when the customer makes or changes the contract. For example, the specifying unit 23 specifies, for example, the V/L “V10L20” of the software name “data storage” with respect to the customer “YY company”, and outputs the specified information to the determination unit 24. An example in which both of the version and the level are specified to advance the processing will be here explained, however, the processing can also be advanced in the same manner even by only one of both.

The determination unit 24 is a processing unit that determines whether or not the software whose version is specified by the specifying unit 23 is executed at a data center to be used by the customer. Specifically, the determination unit 24 specifies the DC to be used by the customer from the contract information of the customer. Also, the determination unit 24 acquires the software name and the V/L to be used by the customer from the specifying unit 23. The determination unit 24 determines whether or not the acquired software name and V/L are registered in association with the specified DC with reference to the center information database 15, and outputs the determination result to the instructing unit 25

In explanation with the customer “YY company”, for example, the determination unit 24 acquires the V/L “V10L20” of the software name “data storage” from the specifying unit 23 as information of software to be used by the customer “YY company”. The determination unit 24 searches the customer information database 14 using the customer “YY company” as a keyword, and specifies the use-center name “Kansai center”. Subsequently, the determination unit 24 searches the center information database 15 using the use-center name “Kansai center” as a keyword, and determines whether or not the V/L “V10L20” of the software name “data storage” is stored.

When the V/L “V10L20” of the software name “data storage” has been stored, the determination unit 24 outputs the fact to the instructing unit 25 that it has already been stored, and when the V/L “V10L20” of the software name “data storage” has not been stored, outputs the fact to the instructing unit 25 that it has not been stored. In this case, the determination unit 24 also outputs information such as the customer code that specifies the customer, “software name and V/L” to be used by the customer, or the like.

The instructing unit 25 is a processing unit that determines whether or not software of the version to be used by the customer is saved in the data center to be used by the customer and performs a download instruction in accordance with the determination result. Specifically, when it is determined that the software of the version to be used by the customer is not executed in the data center to be used by the customer, the instructing unit 25 instructs the data center to be used by the customer to download the software of the version to be used by the customer from another data center that holds the software of the version to be used by the customer. However, when “transfer-unable point” is registered in association with the DC to be used by the customer in the center load database 16, the instructing unit 25 excludes the registered “transfer-unable point” from download sources. The instructing unit 25 may also cause a customer at the time of a new contract to download software to be used from the control center 1.

For example, when receiving from the determination unit 24 information presenting that software of the version to be used by the customer has been already stored, the instructing unit 25 searches the customer information database 14 using the received customer code as a keyword, and specifies the data center “Kansai center” to be used by the customer. The instructing unit 25 sends messages instructing that a download is unnecessary to management servers in the “Kansai center” used by the customer, an administrator of the “Kansai center”, or the like. Information on management servers in the data centers, administrators, or the like is previously stored in the storage 12.

On the contrary, when receiving from the determination unit 24 information presenting that the software of the version to be used by the customer has not been stored, the instructing unit 25 searches the customer information database 14 using the “software name (data storage), V/L (V10L20)” used by the received customer as a keyword. The instructing unit 25 specifies the data center “Tokyo center” with which the “software name (data storage), V/L (V10L20)” are associated. The instructing unit 25 instructs the management server in the “Kansai center” to be used by the customer or the administrator of the “Kansai center” to download the program of the software (data storage) of the V/L (V10L20) from the “Tokyo center”.

Now, the instructing unit 25 determines from which of the data centers the software of the version to be used by the customer is downloaded in a predetermined method when a plurality of data centers are specified as download source data centers. However, when “transfer-unable point” is registered in association with the DC to be used by the customer in the center information database 15, the instructing unit 25 excludes the registered “transfer-unable point” from the download sources.

For example, the instructing unit 25 refers to the center load database 16, and can determine the DC whose communication load situation is smaller as the download source. As an example, explanation will be given in a state in which the “software name (data storage), V/L (V10L20)” is determined to be stored in “Tokyo center” and “Kyushu center”.

When the communication load situations of “Tokyo center” and “Kyushu center” respectively are “10%” and “50%”, the instructing unit 25 instructs “Kansai center” to be used by the customer to download the software from the “Tokyo center”.

The instructing unit 25 refers to the center load database 16, and can determine the DC whose point distance is closer as a download source. For example, when the point distance between “Kansai center” to be used by the customer and “Tokyo center” is “300 Km” and that between “Kansai center” and “Kyushu center” is “280 Km”, the instructing unit 25 instructs “Kansai center” to be used by the customer to download the software from the “Kyushu center”.

Flow of Processing

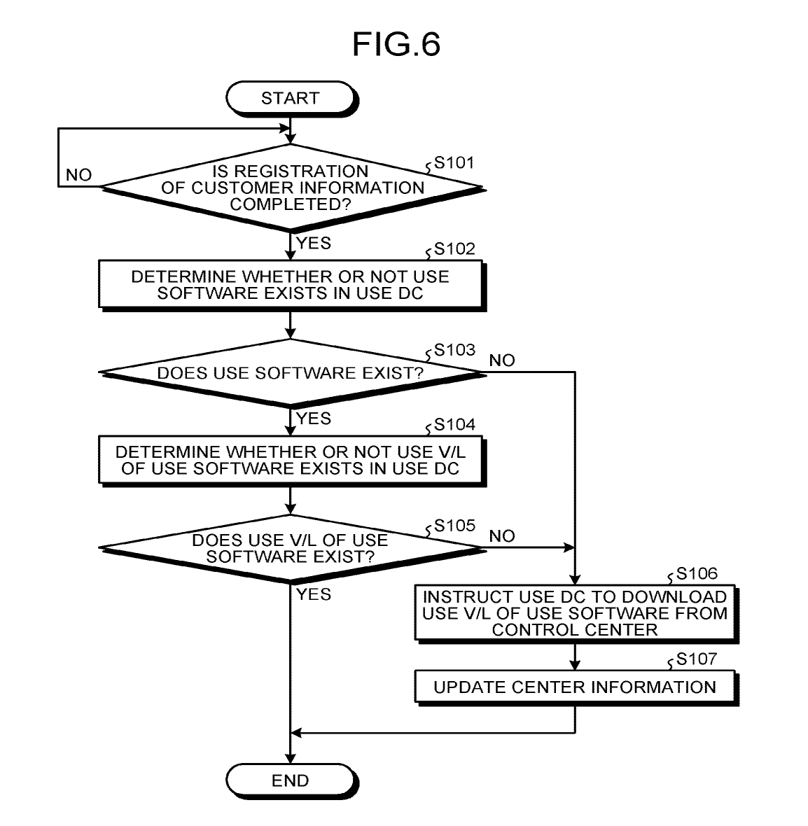

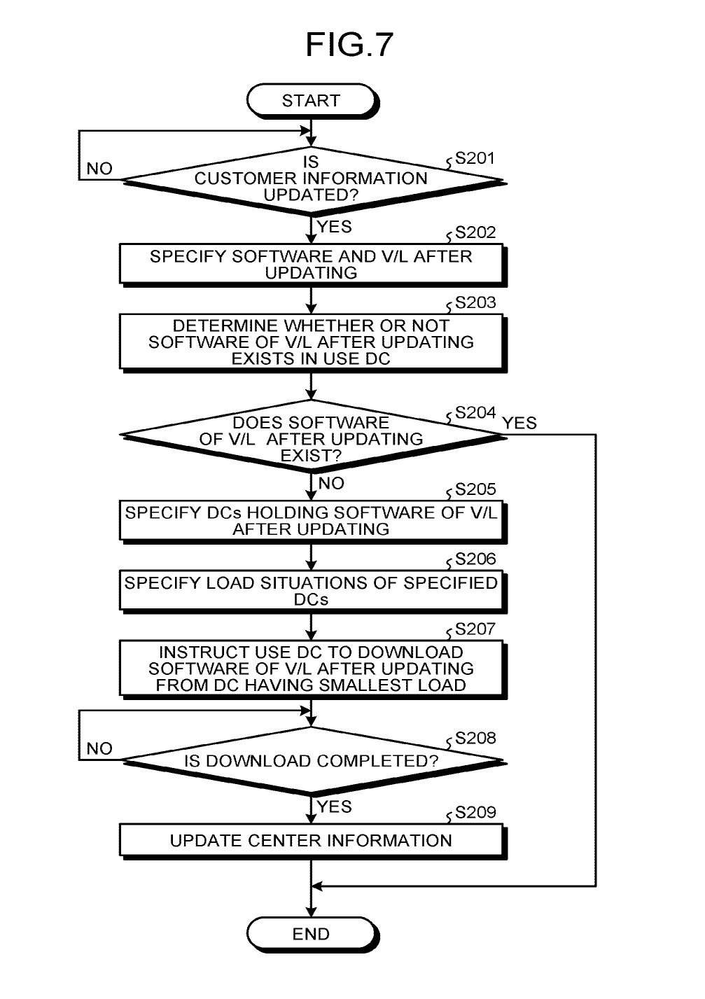

Next, the flow of processing that is performed by the management server 10 of the control center 1 will be explained with reference to FIGS. 6 and 7. Processing at a customer contract and processing at contract change will be explained here.

Processing at Contract

FIG. 6 is a flowchart illustrating the flow of processing when a contract is made with a customer. As illustrated in FIG. 6, when registration of the customer information is completed (S101: Yes), the determination unit 24 determines whether or not the use software to be used by the customer exists in the use DC to be used by the customer (S102).

When the use software exists in the use DC (S103: Yes), the determination unit 24 determines whether or not V/L to be used by the customer exists in the use DC (S104). When the V/L of the use software exists in the use DC (S105: Yes), the determination unit 24 terminates the processing.

On the contrary, when the determination unit 24 determines that the use software does not exist in the use DC (S103: No), or when the determination unit 24 determines that the V/L of the use software does not exist in the use DC (S105: No), Step S106 and later are executed. Specifically, the instructing unit 25 instructs the use DC to download the V/L of the use software from the control center 1 (S106), and then the instructing unit 25 updates the center information database 15 in accordance with the downloaded information (S107).

Processing at Contract Change

FIG. 7 is a flowchart illustrating the flow of processing when the contract is changed. As illustrated in FIG. 7, when the updating of the customer information of the customer information database 14 is performed (S201: Yes), the specifying unit 23 refers to the customer information database 14, and specifies software after updating and the V/L of the updated software (S202).

Next, the determination unit 24 refers to the center information database 15, and determines whether or not the software of the V/L after updating exists in the use DC (S203). Here, when the software of the V/L after updating exists in the use DC (S204: Yes), the determination unit 24 terminates the processing.

On the contrary, when the software of the V/L after updating does not exist in the use DC (S204: No), the instructing unit 25 refers to the center information database 15, and specifies data centers that hold the software of the V/L after updating (S205).

Next, the instructing unit 25 refers to the center load database 16, and specifies load situations of the data centers specified in Step S205 (S206). The instructing unit 25 specifies a DC whose load is smallest among the data centers specified in Step S205, and instructs the DC to be used by the customer to download the software of the V/L after updating from the specified DC (S207).

Thereafter, when receiving from the DC to be used by the customer a notification that indicates the completion of the download (S208: Yes), the instructing unit 25 updates the center information database 15 with respect to information on the use software of the DC to be used by the customer (S209).

Specific Example

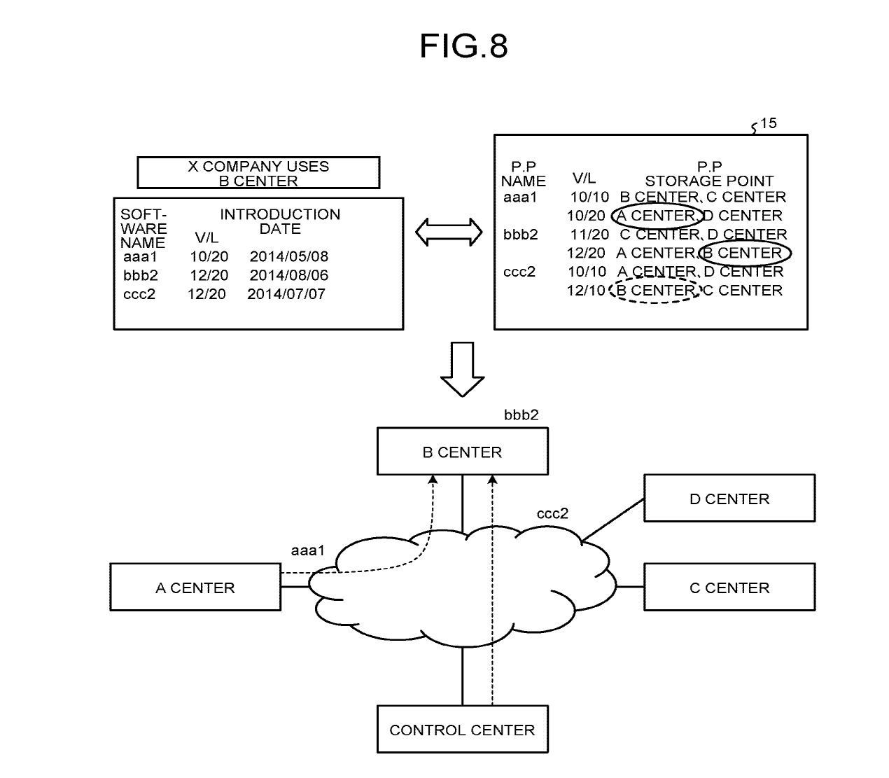

Next, a specific example of downloading the software by the DC to be used by the customer will be explained. FIG. 8 is a diagram illustrating a specific example of the download source. In FIG. 8, the customer “X company” is assumed to use the data center “B center”, and further to use the software name “aaa1” of the V/L “10/20”, the software name “bbb2” of the V/L “12/20”, and the software name “ccc2” of the V/L “12/20”. The control center 1, the A center, the C center, a D center exist other than the data center B.

In such a state, the management server 10 determines a download source of the software name “aaa1” to be used by the X company. Specifically, the management server 10 refers to the center information database 15, and specifies that the software name “aaa1” of the V/L “10/10” is saved in the B center and the C center, and the software name “aaa1” of the V/L “10/20” is saved in the A center and the D center. As a result, the management server 10 makes the B center download the software name “aaa1” of the V/L “10/20” from the A center.

Next, the management server 10 determines the download source of the software name “bbb2” to be used by the X company. Specifically, the management server 10 refers to the center information database 15, and specifies that the software name “bbb2” of the V/L “11/20” is saved in the C center and the D center, and the software name “bbb2” of the V/L “12/20” is saved in the A center and the B center. As a result, because the software name “bbb2” of the V/L “12/20” is saved in the B center, the management server 10 determines that download is unnecessary.

Finally, the management server 10 determines a download source of the software name “ccc2” to be used by the X company. Specifically, the management server 10 refers to the center information database 15, and specifies that the software name “ccc2” of the V/L “10/10” is saved in the A center and the D center, and the software name “ccc2” of the V/L “12/10” is saved in the B center and the C center. As a result, because the software name “ccc2” of the V/L “12/20” is not saved in any data centers, the management server 10 makes the B center download the software name “ccc2” of the V/L “12/20” from the control center 1.

Effects

In this way, because the software to be used by the customer can be downloaded from the DC whose load is smaller or that is closer, the management server 10 can restrain concentration of download from the control center 1 and reduce processing load during downloading. Also, because the processing load during downloading can be reduced, a time can be shortened in which each of the data centers downloads the software to be used. As a result, a start of service to the customer can also be accelerated, and thus reliability of the service is improved.

### Second Embodiment

The download of the software has been explained in the first embodiment, but not limited thereto, application of updated programs or patches of the software can be processed in the same manner. Therefore, in the second embodiment, the case of the application of the updated patches among the updated programs and patches of the software will be explained as an example.

Overall Configuration

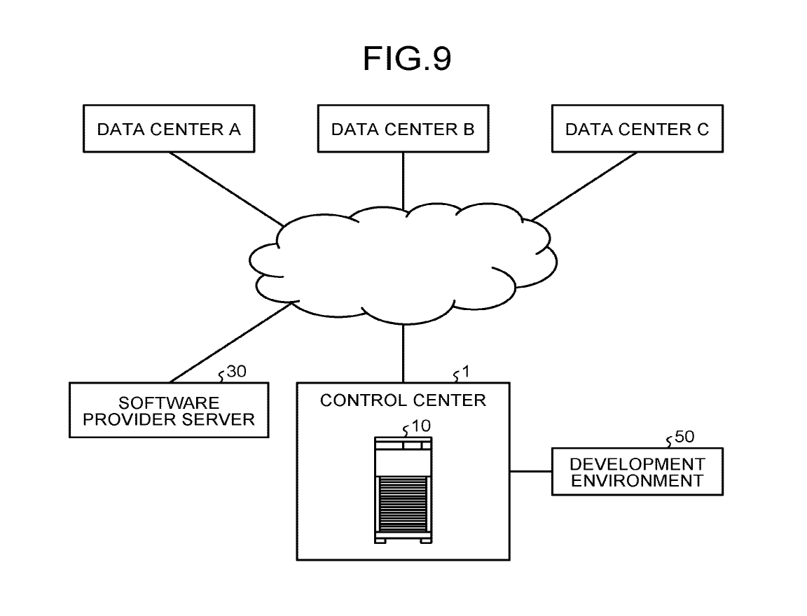

FIG. 9 is a diagram illustrating an overall configuration example of a system according to the second embodiment. As illustrated in FIG. 9, it differs from the first embodiment in that a software provider server 30 and a development environment 50 are included.

The software provider server 30 is a server device that delivers update patches of a variety of software. The development environment 50 is isolated from commercial networks and is connected to the control center 1. Servers, specifications of which are similar to those of the servers that operate in each of the data centers, operate in the development environment 50.

In such a system, the management server 10 of the control center 1 acquires the update patch from the software provider server 30 when the update patch to predetermined software arises. The management server 10 applies the update patch to the predetermined software in the development environment 50 that has no influence on the service to be provided to the customer. Thereafter, after no occurrence of abnormality has been checked, the management server 10 instructs the data center that performs the predetermined software to apply the update patch.

Flow of Processing

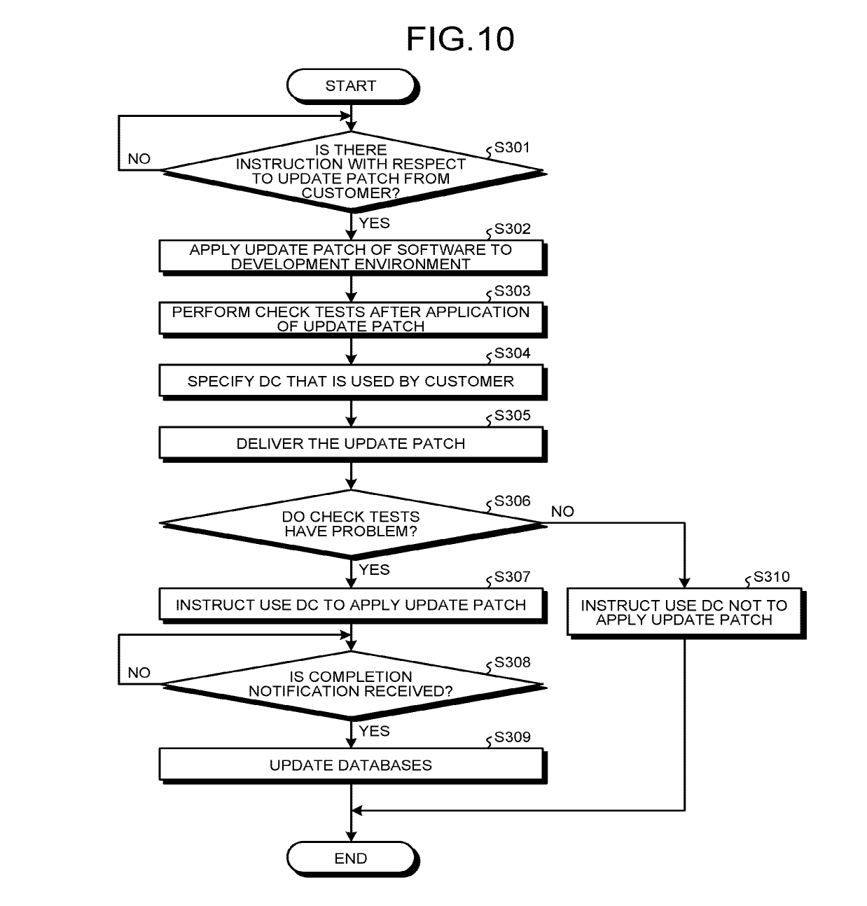

FIG. 10 is a flowchart illustrating the flow of processing when the patch is applied. As illustrated in FIG. 10, when receiving an instruction that indicates the application of the update patch from the customer (S301: Yes), the instructing unit 25 acquires the update patch of the software from the software provider server 30, and applies the update patch to the corresponding server of the development environment 50 (S302).

Next, the instructing unit 25 performs check tests after application of the update patch (S303). The check tests are ordinary tests that perform, for example, a check on absence or presence of errors, a check on performing normal processing, or the like.

The instructing unit 25 refers to the customer information database 14, specifies a DC to be used by the customer (S304), and delivers the update patch to the specified use DC (S305).

Thereafter, when a problem is absent in the check tests (S306: Yes), the instructing unit 25 instructs the use DC to apply the update patch (S307). When receiving from the use DC a notification that indicates the completion of the application of the update patch (S308: Yes), the instructing unit 25 updates the customer information database 14 and the center information database 15 in accordance with the update information (S309).

On the contrary, when a problem is present in the check tests (S306: No), the instructing unit 25 instructs the use DC not to apply the update patch (S310).

Effects

In this way, the management server 10 can apply the update patch to each of the data centers that holds target software after the absence of malfunction by the update patch has been checked. As a result, occurrence of failure by the update patch can be restrained and reliability can also be improved.

### Third Embodiment

The embodiments according to this invention has been explained, however, this invention may be exploited in various different embodiments other than the aforementioned embodiments.

System

The components of the apparatuses illustrated in the drawings are functionally conceptual and need not necessarily be physically configured in the manner illustrated in the drawings. That is, specific forms of distribution and integration of the apparatuses are not limited to those illustrated in the drawings. Further, for each processing function performed by each apparatus, all or any part of the processing function may be implemented by a CPU and a program analyzed and executed by the CPU or may be implemented as hardware by wired logic.

Of the processes described in the embodiments, all or part of a process described as being performed automatically may be performed manually. Alternatively, all or part of a process described as being performed manually may also be performed automatically by known methods. In addition, the processing procedures, control procedures, specific names, and information including various kinds of data and parameters illustrated in the above-described document and drawings may be arbitrarily changed unless otherwise specified.

Hardware

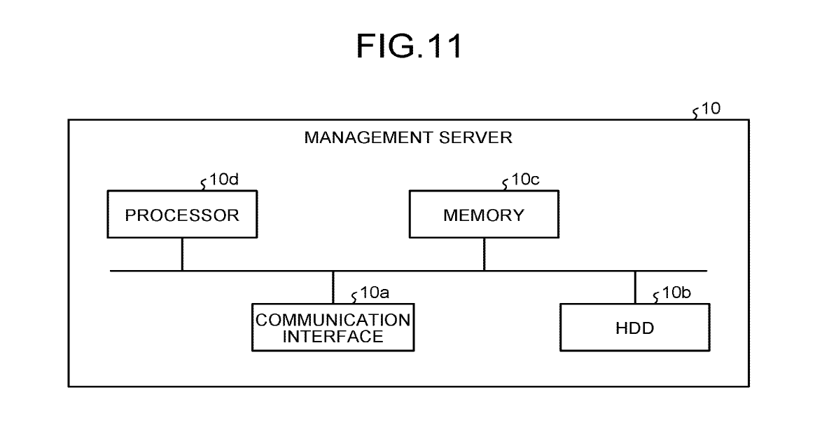

FIG. 11 is a diagram illustrating a hardware configuration example. As illustrated in FIG. 11, the management server 10 includes a communication interface 10a, a hard disk drive (HDD) 10b, a memory 10c, and a processor 10d. Each of the units illustrated in FIG. 11 is connected to each other via a bus or the like.

The communication interface 10a is an interface, such as a network interface card, which controls communication with other apparatuses. The HDD 10b stores the programs or the databases that operate the functions having illustrated in FIG. 1 or the like.

The processor 10d executes a process that executes each of the functions having explained in FIG. 2 or the like by loading from the HDD 10b or the like a program that executes processing similar to that each of the processing units illustrated in FIG. 2 or the like performs and expanding the program in the memory 10c.

In other words, the process executes a function similar to that each of the processing units included in the management server 10 performs. Specifically, the processor 10d loads a program that have functions similar to those of the acquisition unit 21, the load measuring unit 22, the specifying unit 23, the determination unit 24, and the instructing unit 25 from the HDD 10b or the like. The processor 10d executes processes that execute processing similar to that of the acquisition unit 21, the load measuring unit 22, the specifying unit 23, the determination unit 24, and the instructing unit 25.

In this way, the management server 10 operates the information processing device that executes a management method by loading and executing the program. In addition, the management server 10 can also realize the functions similar to those of the aforementioned embodiments by loading the program from a recording medium by a medium reading device and executing the loaded program. The program according to other embodiments is not limited to be executed by the management server 10. For example, when other computer or server executes a program, or when they execute the program in cooperation with each other, this invention can be applied similarly.

According to an aspect of the embodiments, a processing load when downloading software can be reduced.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A management apparatus that manages data centers, comprising:
a memory; and
a processor that is connected to the memory, wherein the processor executes a process including:
specifying a version of software to be used by a user;
determining whether or not the software of the version specified at the specifying is held in a first data center to be used by the user, and
instructing the first data center to download the software of the version from a second data center that holds the software of the version when the software of the version is not held in the first the data center.

2. The management apparatus according to claim 1, wherein the process further includes:
selecting, when a plurality of download sources hold the software of the version, one of the download sources on a basis of load information on a communication situation of each of the download sources or a distance between each of the download sources and the first data center, wherein
the instructing includes instructing the first data center to download the software of the version from the download source selected at the selecting.

3. The management apparatus according to claim 1, wherein the process further includes instructing, when an update patch for predetermined software is produced, a data center that holds the predetermined software to apply the update patch after the update patch is applied to the predetermined software and no occurrence of abnormality is checked under an environment that has no influence on service to be provided to the user.

4. A management method comprising:
specifying a version of software to be used by a user, using a processor;
determining whether or not the software of the version specified at the specifying is held in a first data center to be used by the user, using the processor; and
instructing the first data center to download the software of the version from a second data center that holds the software of the version when the software of the version is not held in the first data center, using the processor.

5. A non-transitory computer-readable recording medium having stored therein a managing program that causes a management apparatus that manages data centers to execute a process comprising:
specifying a version of software to be used by a user;
determining whether or not the software of the version specified at the specifying is held in a first data center to be used by the user, and
instructing the first data center to download the software of the version from a second data center that holds the software of the version when the software of the version is not held in the first data center.
